(19) United States
(12) Patent Application Publication
(10) Pub. No.: US 2019/0263980 A1
(43) Pub. Date: Aug. 29, 2019

(54) CROSSLINKABLE POLYMER COMPOSITION AND CROSSLINKED POLYMER COMPOSITION

(71) Applicant: Rehau AG + Co., Rehau (DE)

(72) Inventors: VOLKER BÖHM, SPARNECK (DE); KARLHEINZ WINTER, REHAU (DE); ANTON FÖRTIG, ERLANGEN (DE); THOMAS RHÖNISCH, HOF (DE)

(21) Appl. No.: 16/333,946

(22) PCT Filed: Aug. 4, 2017
(86) PCT No.: PCT/EP17/00952

§ 371 Date: Mar. 15, 2019

(30) Foreign Application Priority Data
Sep. 20, 2016 (DE) 102016117664.8

(51) Int. Cl. C08J 3/24; C08F 10/00; C08L 23/00

(52) U.S. Cl. CPC C08J 3/244; C08F 10/00; C08L 2312/00; C08F 2810/20; C08L 23/00

(57) ABSTRACT

The invention relates to a crosslinkable polymer composition (1), comprising a crosslinkable polymer material (2), particularly a polyolefin, preferably a polyethylene, additives (3), a first initiator (4) and a second initiator (5), wherein said first initiator (4) and second initiator (5) are different.

The invention relates to a crosslinkable polymeric composition and a crosslinked polymeric composition, as well as a method for crosslinking the crosslinkable polymeric composition to the crosslinked polymeric composition, and, finally, a molded part of the crosslinked polymeric composition.

Crosslinking of crosslinkable polymeric compositions to crosslinked polymeric compositions is a long known method for producing highly stable, durable and long lasting polymer products.

In particular, the crosslinking of polyethylene to crosslinked polyethylene is carried out on a large scale. One of the main applications is in the field of crosslinked polyethylene pipes, which are used for a variety of purposes such as water supply to buildings, radiator connections, or gas transport.

Also, applications in which a fluid is under high pressure, are often served with such pipes of crosslinked polyethylene, which have a very high compressive strength.

For the production of crosslinked polymeric compositions, very often only a precisely specified polymeric material may be used with very precisely defined rheological properties.

Other polymeric materials of the same family, in particular generally available standard polymers, may not be used for the preparation of such a crosslinkable polymeric composition or only under significant restrictions.

This is highly disadvantageous in that there is very little latitude in the selection of the polymeric materials to be crosslinked, while, in addition, these precisely specified polymeric materials are expensive, which increases the overall cost of crosslinked polymer compositions.

It is an object of the present invention to overcome the described drawback that only very precisely specified polymeric materials are suitable for being subjected to a crosslinking method.

Another object of the present invention is to provide a crosslinked polymeric composition, furthermore to provide a method of crosslinking the crosslinkable polymeric composition to the crosslinked polymeric composition, and, finally, to provide a molded part of the crosslinked polymeric composition.

The solution to the problem of providing a crosslinkable polymeric composition is according to claim 1.

In the context of the present invention, it was recognized that a crosslinkable polymeric composition comprising a crosslinkable polymeric material, in particular a polyolefin, preferably a polyethylene, additive, a first initiator, and a second initiator, wherein the first initiator and the second initiator are different, completely solves the task.

By virtue of the presence according to the invention of a first initiator and a second initiator, wherein the first initiator and the second initiator are different, it is possible to conduct the crosslinking reaction in such a way that the first initiator reacts first of all and leads to crosslinking of the crosslinkable polymeric composition, wherein the resulting crosslinked crosslinkable polymeric composition is moldable and is finally crosslinked after molding by activation of the second initiator after its reaction.

It has proved to be extremely favorable in the context of the present invention if it is provided that the first initiator and the second initiator are selected from the group comprising peroxides, photoinitiators and azo compounds.

The selection of the first initiator and the second initiator from the group comprising peroxides, photoinitiators and azo compounds allows the initiators necessary for crosslinking to be so selected that a tailored crosslinked polymeric composition is produced.

In the context of the present invention, compounds from the group of peroxides may be used as the first and second initiator.

In the context of the present invention, the following peroxides have proven particularly useful: dibenzoyl peroxide, dicumyl peroxide and peroxides which have a tertiary butyl peroxy group, such as hexanes, cyclohexanes, hexynes, valerates, hexanoates, benzoates or carbonates.

Particularly suitable in this context are: dialkyl peroxides, peroxyesters, diacyl peroxides, hydroperoxides, peroxydicarbonates, peroxyketals and cyclic peroxides.

In the context of the present invention, compounds from the group of photoinitiators may also be used as the first and second initiator.

The following photoinitiators have proven to be particularly advantageous in the context of the present invention: substituted benzophenones, with radicals on the carbon atoms as shown below,

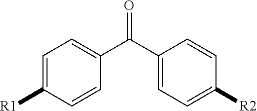

where R1 is selected from
an H atom or
an OR′ radical, where R′ is selected from
   an alkyl radical having 4 to 24 carbon atoms, or
   an alkenyl radical having one double bond and 4 to 24 carbon atoms, or
   an alkynyl radical having one double bond and 4 to 24 carbon atoms,

and

where R2 is selected from
an —O-alkyl radical having 4 to 24 carbon atoms, or
an —O-alkenyl radical having one double bond and 4 to 24 carbon atoms, or
an —O-alkynyl radical having one triple bond and 4 to 24 carbon atoms.

In the context of the present invention, compounds from the group of azo compounds may be used as the first and second initiator.

The following azo compounds have proven to be particularly useful in the context of the present invention:
2,2′-azobisisobutyronitrile (CAS: 78-67-1),
2,2′-azobis(2-methylbutyronitrile) (CAS: 13472-08-7), and
dimethyl-2,2′-azobis(2-methylpropionate) (CAS: 2589-57-3).

For crosslinking the crosslinkable polymeric composition containing as initiator, for example, a peroxide, or a photoinitiator, or an azo compound, this initiator is activated by supplying energy to start the radical reaction, which leads to crosslinking of the crosslinkable polymeric composition.

In the present invention, it may prove to be extremely advantageous, if it is provided that the first initiator and the second initiator have different activation energies.

By providing that the first initiator and the second initiator have different activation energies, the respective initiator may be activated by supplying the respectively necessary activation energy to start the radical reaction, which leads to crosslinking of the crosslinkable polymeric composition. Crosslinking of the crosslinkable polymeric composition may involve pre-crosslinking or final crosslinking.

In the context of the invention, the term “pre-crosslinking” is understood to mean that the crosslinkable composition is crosslinked to a certain degree, but not completely, by a radical reaction. In this case, the viscosity of the polymeric composition increases so that the crosslinked crosslinkable polymeric composition has a higher viscosity than the crosslinkable - but not crosslinked - polymeric composition. Due to the increase in viscosity, it is possible to form the crosslinked crosslinkable polymeric composition, for example, by pressing it through a tool to form a pipe, wherein the shape of the crosslinked crosslinkable polymeric composition thus formed, then remains stable. It has proven to be very practical when it is anticipated that the degree of crosslinking of the crosslinked crosslinkable polymer composition is <65% according to DIN EN ISO 10147.

In the context of the invention, ready-to-use crosslinking means that the crosslinked crosslinkable polymeric composition is further crosslinked until the degree of crosslinking reaches 70 to 95% according to DIN EN ISO 10147.

It may be provided in one embodiment of the invention in a favorable manner that the first initiator and the second initiator are contained in different amounts.

Because the first initiator and the second initiator may be present in different amounts in the crosslinkable polymeric composition, it is possible to determine and comply with the degree of crosslinking prior to the actual final crosslinking.

In a particularly advantageous embodiment of the present invention, it may be provided that in the event that the first initiator and the second initiator are peroxides, the first initiator will have a lower light-off temperature than the second initiator.

The light-off temperature in the context of the invention is understood to mean the temperature at which the peroxide decomposes to such an extent that it generates radicals that start the radical reaction, which leads to crosslinking of the crosslinkable composition.

The light-off temperature may be, in particular, the temperature at which 90% of the possible or desired crosslinking of the crosslinkable composition is achieved within a period of 12 minutes.

In particular, the first peroxide—i.e. the first initiator—may be so selected that it has a light-off temperature in the range of the melting point of the polyethylene.

The second peroxide—the second initiator—is then selected so that the light-off temperature is higher than that of the first peroxide.

By doing so, polyethylene may be crosslinked to the crosslinked polyethylene in a very practical way. For this purpose, the crosslinkable polymeric composition is initially heated beyond the light-off temperature of the first initiator, but not as high as the light-off temperature of the second initiator.

This thus leads to a crosslinking of the crosslinkable polymeric composition, which may be subsequently formed, for example, as a pipe. The co-crosslinking operation may be carried out, for example, in an extruder, whereupon the crosslinked crosslinkable polymeric composition is forced through a pipe die provided on the extruder to form a pipe.

Through a downstream method, in which the elevated temperature acts on the pipe, wherein the higher temperature is higher than the light-off temperature of the second initiator, the formed crosslinked crosslinkable polymeric composition is then further crosslinked to result in a final crosslinked polyethylene crosslinked pipe.

In a further particularly favorable embodiment of the present invention it may be provided that in the event of the first initiator being a peroxide and the second initiator being a photoinitiator, the first initiator is activated by a temperature that is higher than its light-off temperature, while the second initiator is activated by the action of light.

This allows polyethylene to be crosslinked to crosslinked polyethylene in a very practical way. For this purpose, the crosslinkable polymeric composition is first heated beyond the light-off temperature of the first initiator.

This leads to a crosslinking of the crosslinkable polymeric composition, which may be subsequently formed, for example, as a pipe. The co-crosslinking operation may be carried out, for example, in an extruder, whereupon the crosslinked crosslinkable polymeric composition is forced through a pipe die provided on the extruder to form a pipe.

Through a downstream method in which appropriate light is applied to the pipe, activation of the second initiator—the photoinitiator—then crosslinks the formed crosslinked crosslinkable polymeric composition to yield a final crosslinked pipe of crosslinked polyethylene.

It is to be understood that according to the present invention, the first initiator and the second initiator are independently selectable from the group comprising peroxides, photoinitiators and azo compounds, so that any combinations are possible.

Thus, the first initiator may be a photoinitiator, while the second initiator may be a peroxide, or the first initiator may be an azo compound while the second initiator may be an azo compound.

In the context of the present invention, it may prove to be extremely advantageous if it is provided that the polymeric material is a polyolefin, in particular a polyethylene having a density according to DIN EN ISO 1183 of 0.90 to 0.960 g/cm³, preferably 0.944 to 0.956 g/cm³, and with an MFR according to DIN EN ISO 1133 at 190° C./21.6 kg of 2 to 40 g/10 min.

By selecting the polymeric material in the crosslinkable polymeric composition as defined above, many different polyethylenes may be used for this crosslinking technique. In particular, standard types for crosslinking may now also be used. This makes it possible to resort to a broad raw material base, which accordingly simplifies the production of crosslinked polyethylene, while also making it more cost-effective.

In a further development of the present invention, it may prove to be very helpful if it is provided that the additives are selected from stabilizers, in particular thermal and light stabilizers, fillers, lubricants, flow aids, antistatic agents, pigments, method auxiliaries, polymers and the like.

By providing for the crosslinkable polymeric composition of the present invention to contain additives as enumerated above, the crosslinkable polymeric composition may be tailored to the specific technical needs and requirements of the customer.

The object of the present invention to provide a crosslinked polymeric composition undergoes their solution according to claim 8.

According to the invention, a crosslinked polymeric composition may be provided by crosslinking the above-described crosslinkable polymeric composition, wherein the degree of crosslinking according to DIN EN ISO 10147 is between 70 and 95%.

The solution to the problem of specifying a method for crosslinking the crosslinkable polymeric composition is carried out according to claim 9.

In the context of the present invention, it was recognized that the method for crosslinking the crosslinkable polymeric composition described above is characterized in that the crosslinkable polymeric composition is crosslinked in a first step, wherein the viscosity of the crosslinked crosslinkable polymeric composition is greater than the crosslinkable polymeric composition, wherein the crosslinked polymeric composition is forms a formed crosslinked crosslinkable polymeric composition, and, in a second step, the crosslinked polymeric composition is formed from the formed crosslinked crosslinkable polymeric composition by final crosslinking.

Consequently, the method for crosslinking the crosslinkable polymeric composition has a first and a second step, in which the crosslinking and forming take place in the first step and then the final crosslinking in the second step.

In a preferred embodiment of the invention, the first step, i.e. the crosslinking and forming by means of an extruder, the crosslinkable polymeric composition is crosslinked in the extruder and is then formed by a tool provided on the extruder. The final crosslinking then takes place in a second step, in which the formed crosslinked crosslinkable polymer composition is supplied with further activation energy, which leads to the final crosslinking.

Also within the scope of the present invention it is provided that the crosslinkable polymeric composition comprises at least two initiators. In particular, three, four or more initiators may be included. In this way, stepwise crosslinking of the crosslinkable polymeric composition to the crosslinked polymeric composition may be carried out.

The last object of the invention to provide a molded part as its solution is taught in claim 10.

By the present invention, a molded article of the crosslinked polymeric composition as described above may be provided in a simple and inexpensive manner.

The present invention finds wide application in the crosslinking of crosslinkable polymeric materials to produce molded parts such as pipes, fittings, containers, among others, which are particularly resistant and inert.

In particular, molded parts for receiving, storing and conveying fluids, such as water and gases, for example, are easily and inexpensively accessible in this way.

Other important features and advantages of the invention will become apparent from the dependent claims, from the figure, and from the associated description of the figures.

It is to be understood that the features mentioned above and those yet to be explained may be used not only in the particular combination given, but also in other combinations or in isolation, without departing from the scope of the present invention.

The present invention will be described in detail with reference to the accompanying drawing, wherein:

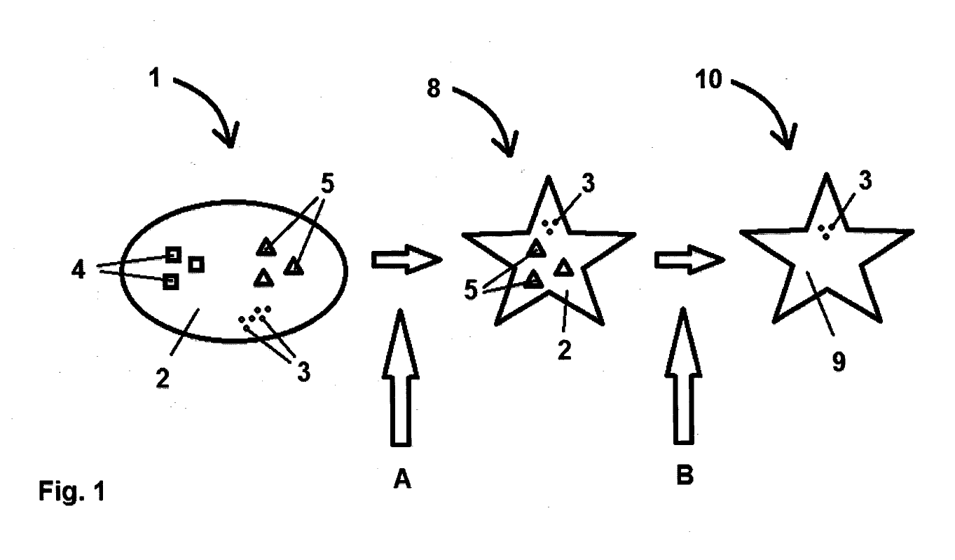

FIG. 1 shows a schematic representation of the crosslinking method and the forming of a crosslinkable polymeric composition to a crosslinked polymeric composition.

FIG. 1 shows, in a schematic representation, the crosslinking method and the forming of the crosslinkable polymeric composition 1.

The crosslinkable polymeric composition 1 is shown in FIG. 1 as an oval on the left side, wherein this is intended to symbolize that the crosslinkable polymeric composition 1 is unformed.

Additives 3 are contained in the crosslinkable polymeric composition 1, for example in the form of thermal and/or light stabilizers.

Polyethylene 2 is contained as the crosslinkable polymeric material in the crosslinkable polymeric composition 1.

Furthermore, the crosslinkable polymeric composition 1 comprises a first initiator 4 and a second initiator 5.

A shaped crosslinked crosslinkable polymeric composition 1 is prepared from the crosslinkable polymeric composition 1 in a first step A.

The first step A comprises the crosslinking and forming of the crosslinkable polymer composition 1.

In crosslinking of the crosslinkable polymeric composition 1 in the first step A, the first initiator 4 in the crosslinkable polymeric composition 1 reacts and crosslinks the crosslinkable polymeric material 2, in this case polyethylene.

Forming to the formed crosslinked crosslinkable polymeric composition 8 can take place by virtue of the higher viscosity of the crosslinked crosslinkable polymeric composition compared with that of the crosslinkable polymeric composition 1.

In FIG. 1, this is illustrated by a star-shaped configuration of the formed crosslinked crosslinkable polymeric composition 8.

Additives 3 are contained in the formed crosslinked crosslinkable polymeric composition 8, namely the above-described thermal and/or light stabilizers, in addition to further crosslinkable polymeric material 2, in this case in the form of polyethylene.

The first initiator 4 is no longer present in the formed crosslinked crosslinkable polymeric composition 8.

The formed crosslinked crosslinkable polymeric composition 8 still has the second initiator 5.

In a second step B, the molded part 10 is prepared from the formed crosslinked crosslinkable polymeric composition 8—without causing any further change in form—by final crosslinking of the formed crosslinked crosslinkable polymeric composition 8 to the crosslinked polymeric composition 9.

In this case, the second initiator 5 is consumed and thus no longer exists in the crosslinked polymeric composition 9.

The additives 3 are still present in the crosslinked polymeric composition 9.

The present invention has been described in detail with reference to the embodiment of the present invention shown in the figure. It is to be understood that the present invention is not limited to the illustrated embodiment, but to the scope of the claims of the present invention.

### LIST OF REFERENCE NUMBERS

1 crosslinkable polymeric composition

2 crosslinkable polymeric material

3 additives

4 first initiator

5 second initiator

8 formed crosslinked crosslinkable polymeric composition

9 crosslinked polymeric composition

10 molded part

A Pre-crosslinking and forms of the crosslinkable polymeric composition

B final crosslinking of the formed crosslinked crosslinkable polymeric composition

1.-10. (canceled)

11. A crosslinkable polymeric composition, comprising:
a crosslinkable polymeric material;
additives;
a first initiator; and
a second initiator;
wherein the first initiator and the second initiator are different.

12. The crosslinkable polymeric composition according to claim 11, wherein the first initiator and the second initiator are selected from the group consisting of peroxides, photoinitiators, azo compounds and combinations thereof.

13. The crosslinkable polymeric composition according to claim 11, wherein the first initiator and the second initiator have different activation energies.

14. The crosslinkable polymeric composition according to claim 11, wherein the first initiator and the second initiator are present in different amounts.

15. The crosslinkable polymeric composition according to claim 11, wherein, if the first initiator and the second initiator are peroxides, the first initiator has a lower light-off temperature than the second initiator.

16. The crosslinkable polymeric composition according to claim 11, wherein the polymeric material is a polyolefin having a density according to DIN EN ISO 1183 of 0.90 to 0.960 g/cm³ and with an MFR according to DIN EN ISO 1133 at 190° C./21.6 kg of 2 to 40 g/10min.

17. The crosslinkable polymeric composition according to claim 11, wherein the additives are selected from the group consisting of stabilizers, fillers, lubricants, flow aids, antistatic agents, pigments, method auxiliaries, polymers and combinations thereof.

18. The crosslinked polymeric composition according to claim 11, wherein the degree of crosslinking according to DIN EN ISO 10147 is between 70% and 95%.

19. A method for crosslinking the crosslinkable polymeric composition according to claim 11, wherein the crosslinkable polymeric composition is crosslinked in a first step, wherein a viscosity of the crosslinked crosslinkable polymeric composition is greater than that of the crosslinkable polymeric composition, wherein the crosslinked crosslinkable polymeric composition is formed to form a formed crosslinked crosslinkable polymeric composition, and is then formed in a second step from the formed crosslinkable crosslinkable polymeric composition by crosslinking the crosslinked polymeric composition.

20. A molded part of the crosslinked polymeric composition according to claim 18.
